(19) United States
(12) Patent Application Publication
(10) Pub. No.: US 2025/0308772 A1
(43) Pub. Date: Oct. 2, 2025

(54) HIGH-PERFORMANCE CERIUM-RICH MISCH-METAL PERMANENT MAGNETIC MATERIAL AND PREPARATION METHOD THEREOF

(71) Applicant: Zhejiang University, Hangzhou (CN)

(72) Inventors: Jiaying JIN, Hangzhou (CN); Wang CHEN, Hangzhou (CN); Zhichang ZHENG, Hangzhou (CN); Liang ZHOU, Hangzhou (CN); Shaoqing REN, Hangzhou (CN); Bo XIN, Hangzhou (CN); Chen WU, Hangzhou (CN); Mi YAN, Hangzhou (CN)

(21) Appl. No.: 19/220,039

(22) Filed: May 27, 2025

(30) Foreign Application Priority Data
Feb. 10, 2025 (CN) 202510145732.8

(51) Int. Cl. H01F 41/02; C22C 28/00; C22C 38/00; C22C 38/06; C22C 38/14; C22C 38/16; C23C 10/30; C23C 10/60; H01F 1/057

(52) U.S. Cl. CPC H01F 41/0293; C22C 28/00; C22C 38/002; C22C 38/005; C22C 38/06; C22C 38/14; C22C 38/16; C23C 10/30; C23C 10/60; H01F 1/0577; C22C 2202/02

(57) ABSTRACT

A preparation method of high-performance cerium (Ce)-rich misch-metal (MM) permanent magnetic materials includes: (1) an as-sintered Ce-rich MM permanent magnetic substrate magnet is prepared; (2) a composite diffusion source is obtained by proportionally mixing rare earth (RE) hydride powder and nanometer metallic powder, and the as-sintered Ce-rich MM permanent magnetic substrate magnet is performed with a first surface diffusion treatment using the composite diffusion source to obtain an intermediate product; (3) the intermediate product is subjected to a second surface diffusion treatment with RE alloy powder; (4) a high-temperature heat treatment is performed; and (5) a low-temperature heat treatment is performed to obtain the high-performance Ce-rich MM permanent magnetic materials.

### CROSS-REFERENCE TO RELATED APPLICATIONS

This application claims the benefit of priority from Chinese Patent Application No. 202510145732.8, filed on Feb. 10, 2025. The content of the aforementioned application, including any intervening amendments thereto, is incorporated herein by reference in its entirety.

### TECHNICAL FIELD

This application relates to rare-earth permanent magnetic materials, and more particularly to a high-performance cerium-rich misch-metal permanent magnetic material and a preparation method thereof.

### BACKGROUND

As third-generation rare earth (RE) permanent magnetic material, the strongest NdFeB magnet possesses superior magnetic energy product to other Sm-based or non-RE permanent magnetic materials. In recent years, the rapid development of wind power generation and new energy vehicles poses gradually increasing demand for NdFeB permanent magnetic material, which is accompanied with overconsumption and resultantly significant price fluctuations of major RE raw materials such as neodymium (Nd), praseodymium (Pr), dysprosium (Dy), and terbium (Tb). Cerium (Ce), as the most abundant RE element in the earth's crust, is able to significantly reduce the cost of RE raw materials for NdFeB magnets and thus has attracted much attention recently. However, pure Ce metal is obtained through complicated separation and purification processes, which not only consume a lot of energy, but also inevitably cause waste discharge and environmental pollution. Comparably, the misch-metal (MM) that can skip multi-step separation and purification processes is considered to be cost-effective for fabricating RE-based permanent magnetic materials, and can consume abundant RE raw materials such as Ce, thereby balancing the utilization of RE resources.

MM is the RE alloy composed of lanthanum (La), Ce, Pr and Nd, which usually exists in the form of paragenetic RE ore, such as the Baiyun Ebo paragenetic RE ore. Due to the high proportion of Ce element within MM (more than 50%) and inferior intrinsic magnetic property of Ce₂Fe₁₄B compound, the magnetocrystalline anisotropy field H_{A} and the saturation magnetization Mₛ of MM₂Fe₁₄B phase are significantly lower than those of (Nd, Pr)₂Fe₁₄B phase. Consequently, compared to the traditional NdFeB magnets prepared from Nd—Pr alloy, the RE permanent magnets directly prepared from the misch-metal exhibit significantly deteriorated magnetic properties, especially the low coercivity (even below 1 kOe), which are widely recognized to be incapable for commercialization.

The grain boundary diffusion process (GBDP) introduces a diffusion source into the interior of the magnets through diffusion heat treatment to form a magnetically hardening shell surrounding the RE₂Fe₁₄B matrix phase grains, so as to enhance the local magnetocrystalline anisotropy field. Meanwhile, the composition and distribution of the grain boundary (GB) phases can be modified, thereby significantly enhancing the coercivity of the GBDP magnet. However, for the Ce-rich misch-metal permanent magnetic material, the presence of REFe₂ intergranular phase seriously restricts the depth of grain boundary diffusion. The majority of the elements within the diffusion source are aggregated in the surface intergranular regions to form large triple junctions (TJs), rather than effectively enter the matrix phase to form the magnetically hardening shell, resulting in low diffusion depth and limited increment level of the coercivity. Higher Ce substitution level in the GBDP magnets usually yields lower coercivity increment level. Therefore, it is necessary to design a more effective GBDP approach to avoid the agglomeration of massive REFe₂ phase at the diffusion surface. Consequently, more diffusion sources can infiltrate into the matrix phase to form the magnetically hardening shell, to improve the diffusion depth, to modify the composition and distribution of the GB phase. Such efforts are crucial to deal with the grand challenge of fabricating high-performance Ce-rich misch-metal permanent magnetic material.

### SUMMARY

In view of the deficiencies in the prior art, this application provides a high-performance cerium (Ce)-rich misch-metal (MM) permanent magnetic material and a preparation method thereof, so as to improve the diffusion efficiency. Technical solutions of this application are described as follows.

In a first aspect, this application provides a method of preparing a cerium-rich misch-metal permanent magnetic material, comprising:
(1) subjecting a raw misch-metal permanent magnetic material to induction melting, strip casting, hydrogen decrepitating, jet milling, and high-temperature sintering to prepare an as-sintered Ce-rich MM permanent magnetic substrate magnet;
(2) proportionally mixing rare earth (RE) hydride powder and nanometer metallic powder to obtain a composite diffusion source (first diffusion source); uniformly coating the obtained composite diffusion source on upper and lower surfaces of the as-sintered Ce-rich MM permanent magnetic substrate magnet, wherein the diffusion source is less than 3% by weight of the as-sintered Ce-rich MM permanent magnetic substrate magnet; and performing a first surface diffusion treatment to obtain a first intermediate product;
(3) uniformly coating a RE alloy powder (second diffusion source) on upper and lower surfaces of the first intermediate product, wherein the RE alloy powder is less than 2% by weight of the as-sintered Ce-rich MM permanent magnetic substrate magnet; and performing a second surface diffusion treatment to obtain a second intermediate product;
(4) subjecting the second intermediate product to a high-temperature heat treatment (first heat treatment) to obtain a third intermediate product; and
(5) subjecting the third intermediate product to a low-temperature heat

treatment (second heat treatment) to obtain the Ce-rich MM permanent magnetic material.

In an embodiment, in step (1), composition of the as-sintered Ce-rich MM permanent magnetic substrate magnet, in weight percentage, is [R_{1-a-b}(Ce₁₋ₓMMₓ)ₐR′_{b}]_{c} Fe_{bal}T_{d}Bₑ, wherein R is selected from the group consisting of neodymium (Nd), praseodymium (Pr) and a combination thereof; R′ is selected from the group consisting of gadolinium (Gd), terbium (Tb), dysprosium (Dy), holmium (Ho), samarium (Sm), and yttrium (Y) and a combination thereof; Ce represents cerium element; MM is a misch-metal comprising 50-60% by weight of Ce, 20-35% by weight of lanthanum (La), 5-10% by weight of Pr, 10-20% by weight of Nd, and less than 2% by weight of other impurity elements; Fe represents iron element; T is selected from the group consisting of cobalt (Co), nickel (Ni), aluminum (Al), copper (Cu), chromium (Cr), gallium (Ga), manganese (Mn), niobium (Nb), zirconium (Zr), titanium (Ti), vanadium (V) and a combination thereof; B represents boron element; and a, x, b, c, d, and e satisfy the following conditions: 0.4≤a≤1, 0≤x≤0.8, 0≤b≤0.15, 28≤c≤35, 0.2≤d≤5, 0.85≤e≤1.

In an embodiment, in step (1), a high-temperature sintering process is performed at 980-1080° C. and at a furnace pressure of ≤10-2 Pa for 2-10 h.

In an embodiment, in step (2), composition of the RE hydride powder, in atomic percentage, is A_{1-f}H_{f}, wherein A is selected from the group consisting of Nd, Pr, La, Ce, Gd, Tb, Dy, Ho and a combination thereof; a weight percentage of Nd and Pr in A is higher than 60%; and H is hydrogen, f satisfies the following condition: 0<f≤0.75.

In an embodiment, in step (2), the nanometer metallic powder is selected from the group consisting of Cu, Ti, zinc (Zn) and an alloy thereof; the nanometer metallic powder has a particle size of 5-500 nm; the weight percentage of the RE hydride powder in the composite diffusion source is higher than 50% and lower than 95%.

In an embodiment, in step (2), the first surface diffusion treatment is performed at 800-950° C. for 2-10 h.

In an embodiment, in step (3), composition of the RE alloy powder, in weight percentage, is A′_{1-g}U_{g}, wherein A′ is selected from the group consisting of Nd, Pr, La, Ce, Gd, Tb, Dy, Ho and a combination thereof; U is selected from the group consisting of Al, Cu, Ga, and Zn, g satisfies the following condition 0.1≤g≤0.4.

In an embodiment, in step (3), the second surface diffusion treatment is performed at 800-920° C. for 2-10 h.

In an embodiment, in step (4), the high-temperature heat treatment is performed at 960-1050°° C. for 0.5-2 h; and in step (5), the low-temperature heat treatment is performed at 300-700° C. for 0.5-5 h.

In an embodiment, in steps (2)-(5), the first surface diffusion treatment, the second surface diffusion treatment, the high-temperature heat treatment, and the low-temperature heat treatment are each performed at a furnace pressure of ≤10⁻³ Pa.

It is to be noted that the induction melting, strip casting, hydrogen decrepitating, jet milling, magnetic alignment, isostatic pressing and high-temperature sintering used in the method of preparing the as-sintered substrate magnet are common technologies in the field of NdFEB permanent magnetic materials. For example, the temperature of induction melting usually needs to be higher than that of the highest melting point of the raw materials. The strip casting is generally controlled with a copper roller line speed of 1-5 m/s. In the hydrogen decrepitating process, the strip casting flakes are generally loaded into a stainless steel tank, with the chamber pressure of the stainless steel tank lower than 10⁻² Pa, and the stainless steel tank is subsequently filled with high-purity hydrogen. Nitrogen is generally chosen as the medium for jet milling.

In a second aspect, this application also provides a high-performance Ce-rich misch-metal permanent magnetic material prepared by the method as described.

Compared with the prior art, this application has the following beneficial effects.
(1) Aiming at the bottleneck problem of low magnetic properties of Ce-rich misch-metal permanent magnetic material, this application carries out a compositional optimization design of the as-sintered Ce-rich MM permanent magnetic substrate magnet. Thus, Ce and MM are co-added to further improve the substitution amount of Ce and reduce the RE raw material cost. Moreover, the compositional optimization design can maximize the interaction effect of multiple RE elements and alloying elements to maintain the intrinsic magnetic properties.
(2) This application designs a two-step surface diffusion treatment process including the first surface diffusion treatment and the second surface diffusion treatment. In the first surface diffusion treatment, RE hydride powder and nanometer metallic powder are mixed proportionally to obtain a composite diffusion source. The nanometer metallic powder has a high specific surface area and surface energy, so that the nano-powder in the diffusion process is more likely to interact with the RE hydride powder, thus improving the diffusion efficiency and uniformity. Preferably, Cu, Ti, and Zn metallic elements are introduced to regulate the size of the matrix phase grains in the subsequent diffusion and heat treatment process, inhibit the abnormal growth of the matrix phase grains, and inhibit the massive formation of REFe₂ intergranular phase. In this context, it provides a preferred microstructure for the second surface diffusion treatment with higher diffusion efficiency. This application also adds highly active RE hydride powder with designated weight percentage in the diffusion source to be higher than 50%. Thus, this application on the one hand improves the wettability and diffusion efficiency of the diffusion powder and reduces the diffusion temperature, and on the other hand, avoids the agglomeration of the metallic elements in the diffusion source, which is an important prerequisite for significantly improving the remanence Bᵣ. The first surface diffusion treatment modifies the composition and distribution of the grain boundary phase, and reduces the content of the REFe₂ intergranular phase in the magnet, so as to substantially improve the remanence Bᵣ of the magnet. The first surface diffusion treatment is a prerequisite for preparing the Ce-rich MM permanent magnetic material with high magnetic performances.
(3) This application further introduces low-melting-point auxiliary alloys containing Ga, Al, Cu and Zn in the second surface diffusion treatment. Thus, the second surface diffusion treatment can construct continuous grain boundary phases with better wettability such as RE-(Ga, Al, Cu, Zn) and RE₆(Fe, Ga, Al, Cu, Zn)₁₄ in Ce-rich MM permanent magnetic materials, to replace the agglomerated REFe₂ intergranular phases in the traditional Ce-rich NdCeFeB magnets, thus creating the diffusion channel and further modifying the microstructure of the GBDP magnets. Moreover, the magnetic isolation between the matrix phase grains is strengthened. In this application, the coercivity H_{cj} of the GBDP magnets is further enhanced on the basis of high remanence Bᵣ. The second surface diffusion treatment is another prerequisite for preparing the Ce-rich MM permanent magnetic material with high magnetic performances.
(4) Aiming at the common problem of Ce-rich NdCeFeB magnets that the diffusion source cannot efficiently enter the matrix phase to form the magnetically hardening shell, this application further carries out the short-time high-temperature heat treatment of the magnets at 960-1050° C. for 0.5-2 h after the two-step surface diffusion treatment. Moreover, the temperature of the short-time high-temperature heat treatment is required to be higher than that of the first and second surface diffusion treatments. According to the differences in the composition design of the substrate magnet and the two-step diffusion sources, the preferred holding temperature and holding time are obtained by numerous experiments to synergistically enhance the diffusion depth. Being different from the traditional high-temperature sintering (its main purpose is to obtain high-density magnets), the subsequent short-time high-temperature heat treatment in this application aims to promote the thermodynamic phase transition and improve the diffusion flux. As a result, the RE elements in the intergranular regions infiltrate into the epitaxial layer of the matrix phase to form the magnetically hardening shell, with resultantly enhanced local magnetocrystalline anisotropy field and inhibited nucleation of reversal domains to enhance the coercivity of diffused magnets. Meanwhile, such a high-temperature heat treatment also controls the intergranular phase transformation, typically, to lower the fraction of REFe₂ phase. The short-time high-temperature heat treatment is another indispensable procedure for preparing the Ce-rich MM permanent magnetic material with high magnetic performances.
(5) On the basis of the high-temperature heat treatment above, this application further carries out low-temperature heat treatment. On the one hand, the low-temperature heat treatment promotes the infiltration of specific elements from the matrix phase into the grain boundary phase. The specific elements refer to the RE elements such as La and Ce with low magnetocrystalline anisotropy field and alloying elements such as Ti and Cu that enter the matrix phases during the high-temperature heat treatment. On the other hand, through the matching design of the heat treatment temperature and heat treatment time, the low-temperature heat treatment promotes the uniform precipitation of the continuous grain boundary phase, forming the coherent/semi-coherent interface with adjacent matrix phase. In this application, the interface lattice mismatch between matrix phase and intergranular phase can be significantly reduced, and thus the coercivity of the GBDP magnet can be greatly enhanced, ultimately obtaining the Ce-rich MM permanent magnetic material with high magnetic performances.
(6) The first surface diffusion treatment, the second surface diffusion treatment, the high-temperature heat treatment and the low-temperature heat treatment in this application need to be carried out sequentially/successively, cannot be skipped, and are highly rely on each other. This application solves the technical problems of difficult regulation of REFe₂ phase, limited diffusion depth and low magnetic properties for the vast domain of Ce and MM based permanent magnetic materials. A series of high-performance Ce-rich MM permanent magnets can be prepared. Furthermore, compared with the traditional GBDP technology, this application greatly reduces the thickness limitation of the GBDP magnet, which can be applied to large-size magnets (≥20 mm).

### BRIEF DESCRIPTION OF THE DRAWINGS

FIG. 1 schematically shows a method of preparing a high-performance Ce-rich MM permanent magnetic material according to an embodiment of Example 1 of this disclosure, where Step 1—high-temperature sintering; Step 2—first surface diffusion treatment; Step 3—second surface diffusion treatment; Step 4—high-temperature heat treatment; and Step 5—low-temperature heat treatment;

FIG. 2a shows micro-morphology (back-scattered electron SEM image) of an as-sintered Ce-rich MM permanent magnetic substrate magnet obtained in high-temperature sintering process of Example 1 of the disclosure;

FIG. 2b shows micro-morphology (back-scattered electron SEM image) of a first intermediate product obtained in a first surface diffusion treatment of Example 1 of the disclosure;

FIG. 2c shows micro-morphology (back-scattered electron SEM image) of a second intermediate product obtained in a second surface diffusion treatment of Example 1 of the disclosure;

FIG. 2d shows micro-morphology (back-scattered electron SEM image) of a third intermediate product obtained in a high-temperature heat treatment of Example 1 of the disclosure; and

FIG. 2e shows micro-morphology (back-scattered electron SEM image) of a Ce-rich MM permanent magnetic material obtained in low-temperature heat treatment of Example 1 of the disclosure.

### DETAILED DESCRIPTION OF EMBODIMENTS

The present disclosure will be further described in detail below in conjunction with the embodiments, which are not intended to limit the disclosure. It should be noted that embodiments of the present disclosure and the features therein may be combined with each other in the case of no contradiction.

### Example 1

An as-sintered Ce-rich MM permanent magnetic substrate magnet was prepared through induction melting, strip casting, hydrogen decrepitating, jet milling, and vacuum high-temperature sintering steps, which was represented by [(Pr_{0.2}Nd_{0.8})_{0.2}(Ce_{0.9}MM_{0.1})_{0.8}]₃₂Fe_{bal}Cu_{0.15}Al_{0.3}Zr_{0.2}Ga_{0.5}B_{0.95} in weight percent. The vacuum high-temperature sintering was performed at 1020°° C. for 3 h. Pr_{0.25}H_{0.75} powder and Cu nano-powder (size of about 30 nm) with the weight ratio of 85:15 were uniformly mixed to obtain the composite diffusion source (first diffusion source). Pr₈₀Ga₂₀ RE alloy powder was used as the second diffusion source. A two-step surface diffusion method was used, where the first surface diffusion treatment was performed with the first diffusion source of 2.5% by weight of the as-sintered Ce-rich MM permanent magnetic substrate magnet, and was performed at 920° C. for 4 h to obtain the first intermediate product; and the second surface diffusion treatment was performed with the second diffusion source of 2% by weight of the as-sintered Ce-rich MM permanent magnetic substrate magnet and performed at 860° C. for 4 h to obtain the second intermediate product. The second intermediate product was subjected to the high-temperature heat treatment at 1020°° C. for 1 h to obtain a third intermediate product. The third intermediate product was then subjected to low-temperature heat treatment at 650° C. for 2.5 h, to obtain the high-performance Ce-rich MM permanent magnetic material (finished magnet), which was tested using a NIM6500C permanent magnet test system. The test results showed that the properties of the as-sintered substrate magnet before the surface diffusion were remanence Bᵣ=9.98 kG, coercivity H_{cj}=3.91 kOe, maximum energy product (BH)ₘₐₓ=19.96 MGOe; and the properties of the finished magnet after the diffusion were Bᵣ=10.50 KG, H_{cj}=9.46 kOe, and (BH)ₘₐₓ=25.40 MGOe.

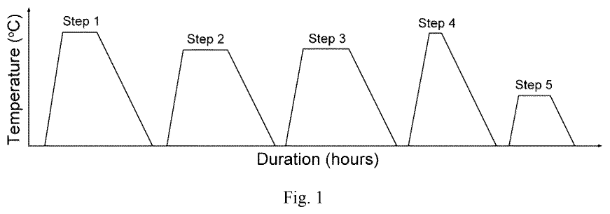

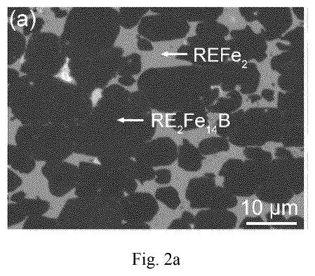

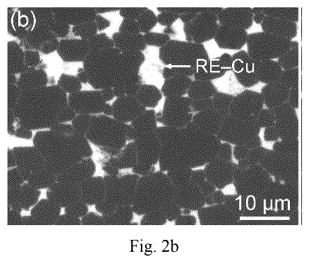

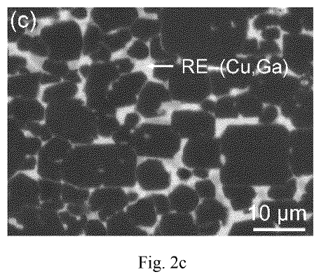

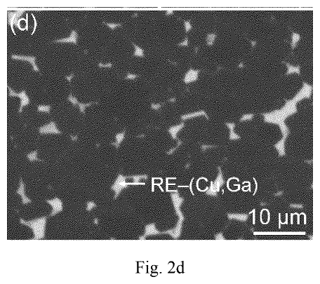

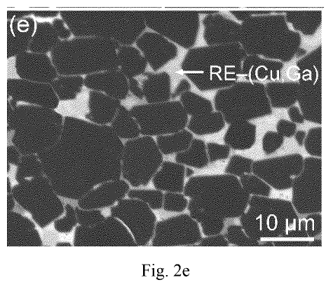

Referring to FIGS. 1 and 2a-2e, Step 1—high-temperature sintering at 1020°° C. for 3 h is required for sufficient liquid-phase-sintering and desired magnet density. As shown in FIG. 2a, for the as-sintered Ce-rich MM permanent magnetic substrate magnet with the composition of [(Pr_{0.2}Nd_{0.8})_{0.2}(Ce_{0.9}MM_{0.1})_{0.8}]₃₂Fe_{bal}Cu_{0.15}Al_{0.3}Zr_{0.2}Ga_{0.5}B_{0.95} in weight percent, no large pores can be identified within the fully densified magnet processed via high-temperature sintering. Besides, from the back-scattered electron mode, two phases with different image contrasts can be identified, one phase with the dark contrast corresponds to the RE₂Fe₁₄B matrix phase, the other phase with the light-grey contrast corresponds to the REFe₂ intergranular phase. It is evident that for the as-sintered substrate magnet containing high Ce concentration, REFe₂ phase is the dominant intergranular phase with high fraction.

Step 2—first surface diffusion treatment at 920° C. for 4 h is required for the infiltration of the first diffusion source composed of Pr_{0.25}H_{0.75} powder and Cu nano-powder. As shown in FIG. 2b, for the first intermediate product obtained in the first surface diffusion treatment, the dominant intergranular phase transforms from the light-grey-contrast REFe₂ phase to the bright-contrast RE-Cu phase. The fraction of REFe₂ phase is massively reduced to enhance the remanence. Consequently, the diffusion efficiency of the first and the following second surface diffusions can be guaranteed.

Step 3—second surface diffusion treatment at 860° C. for 4 h is required for the infiltration of second diffusion source composed of low-melting-point Pr₈₀Ga₂₀ RE alloy powder. As shown in FIG. 2c, for the second intermediate product obtained in the second surface diffusion treatment, the dominant RE-(Cu, Ga) intergranular phase forms with more REs and alloying elements Cu/Ga segregated in the intergranular regions to construct continuous grain boundary layers and to enhance the coercivity.

Step 4—high-temperature heat treatment at 1020° C. for 1 h is required. As shown in FIG. 2d, for the third intermediate product obtained in the high-temperature heat treatment, more REs infiltrate into the matrix phase to form the Nd/Pr-rich magnetically hardening shell. Due to the well-controlled synergy of temperature and time, together with the design of former first composite and second diffusion sources, no abnormal gain growth is identified, which is beneficial to obtain high-performance final magnets. The dominant RE-(Cu, Ga) intergranular phase also appears with lowered fraction.

Step 5—low-temperature heat treatment at 650° C. for 2.5 h is required. As shown in FIG. 2e, for the final finished magnet obtained in the low-temperature heat treatment, more RE-(Cu, Ga) intergranular phase in both forms of triple junctions and continuous grain boundaries can be identified. In this step, the coercivity value is greatly enhanced.

### Comparative Example 1

Comparative Example 1 differed from Example 1 in the selection of the diffusion source for the first surface diffusion treatment. The diffusion source for the first surface diffusion treatment was Pr_{0.25}H_{0.75} powder alone, and the Cu nano-powder was not used. The test results of the NIM6500C permanent magnet test system showed that the performances of the finished magnet after diffusion were Bᵣ=10.05 KG, H_{cj}=8.10 kOe, (BH)ₘₐₓ=22.51 MGOe. The remanence and the maximum energy product of the finished magnet were significantly lower than that of the finished magnet in Example 1.

### Comparative Example 2

Comparative Example 2 differed from Example 1 in a weight ratio of raw materials of the diffusion source for the first surface diffusion treatment. Pr_{0.25}H_{0.75} powder and Cu nano-powder were mixed uniformly in the weight ratio of 45:55 to obtain the composite diffusion source for the first surface diffusion treatment. The test results of the NIM6500C permanent magnet test system showed that the performances of the finished magnet after diffusion were Bᵣ=10.13 kG, H_{cj}=3.02 kOe, (BH)ₘₐₓ=15.72 MGOe. The remanence, coercivity and maximum energy product of the finished magnet were significantly lower than that of the finished magnet in Example 1.

### Comparative Example 3

Comparative Example 3 differed from Example 1 in that after the as-sintered Ce-rich MM permanent magnetic substrate magnet was subjected to the first and second surface diffusion treatments, the magnet was not subjected to high-temperature heat treatment, and was directly subjected to low-temperature heat treatment. The test results of the NIM6500C permanent magnet test system showed that the properties of the finished magnet after diffusion were Bᵣ=10.15 KG, H_{cj}=6.00 kOe, (BH)ₘₐₓ=21.65 MGOe. The remanence, coercivity and maximum energy product of the finished magnet were significantly lower than that of the finished magnet in Example 1.

### Comparative Example 4

Comparative Example 4 differed from Example 1 in that the order of the first surface diffusion treatment and the second surface diffusion treatment was reversed, i.e., the second surface diffusion treatment was carried out first, and then the first surface diffusion treatment was carried out. The test results of the NIM6500C permanent magnet test system showed that the properties of the finished magnet after diffusion were Bᵣ=10.28 KG, H_{cj}=6.50 kOe, (BH)ₘₐₓ=22.17 MGOe. The remanence, coercivity and maximum energy product of the finished magnet were significantly lower than that of the finished magnet in Example 1.

### Example 2

An as-sintered Ce-rich MM permanent magnetic substrate magnet was prepared through induction melting, strip casting, hydrogen decrepitating, jet milling, and vacuum high-temperature sintering steps, which was represented by [(Pr_{0.2}Nd_{0.8})_{0.45}(Ce_{0.6}MM_{0.4})_{0.55}]₃₀Fe_{bal}Co_{0.4}Cu_{0.15}Al_{0.3}Ti_{0.15}Ga_{0.4}B_{0.92} in weight percent. The vacuum high-temperature sintering was performed at 1040° C. for 3 h. (Nd₈₀Pr₂₀)_{0.25}H_{0.75} powder and Ti nano-powder (size of about 60 nm) with the weight ratio of 90:10 were uniformly mixed to obtain the first composite diffusion source (first diffusion source). The Pr₈₀Al₁₀Ga₅Cu₅ RE alloy powder was used as the second diffusion source. A two-step surface diffusion method was used, where the first surface diffusion treatment was performed with the first diffusion source with 2.5% by weight of the as-sintered Ce-rich MM permanent magnetic substrate magnet, and was performed at 940° C. for 2 h to obtain the first intermediate product; and the second surface diffusion treatment was performed with the second diffusion source with 1.5% by weight of the as-sintered Ce-rich MM permanent magnetic substrate magnet and performed at 850° C. for 4 h to obtain the second intermediate product. The second intermediate product was subjected to the high-temperature heat treatment at 1050° C. for 0.5 h to obtain a third intermediate product. The third intermediate product was then subjected to low-temperature heat treatment at 480° C. for 3 h to obtain the high-performance Ce-rich MM permanent magnetic material (finished magnet), which was tested using a NIM6500C permanent magnet test system. The test results showed that the properties of the as-sintered substrate magnet before the surface diffusion were Bᵣ=12.02 KG, H_{cj}=5.30 kOe, (BH)ₘₐₓ=30.06 MGOe; and the properties of the finished magnet after the diffusion were Bᵣ=12.35 KG, H_{cj}=12.28 kOe, and (BH)ₘₐₓ=33.41 MGOe.

### Comparative Example 5

Comparative Example 5 differed from Example 2 in that after the as-sintered Ce-rich MM permanent magnetic substrate magnet was subjected to the first surface diffusion treatment, the magnet was not subjected to the second surface diffusion treatment, i.e., the as-sintered substrate magnet was directly subjected to high-temperature and subsequent low-temperature heat treatments after the first surface diffusion treatment. The test results of the NIM6500C permanent magnet test system showed that the properties of the finished magnet after the diffusion were Bᵣ=12.23 KG, H_{cj}=9.78 kOe, (BH)ₘₐₓ=31.86 MGOe. The coercivity of the finished magnet was significantly lower than that of the finished magnet in Example 2.

### Comparative Example 6

Comparative Example 6 differed from Example 2 in the temperature of the high-temperature heat treatment after the two-step surface diffusion treatment. The high-temperature heat treatment was performed at 1080° C. The test results of the NIM6500C permanent magnet test system showed that the properties of the finished magnet after the diffusion were Bᵣ=12.29 KG, H_{cj}=9.52 kOe, (BH)ₘₐₓ=31.49 MGOe. The coercivity of the finished magnet was significantly lower than that of the finished magnet in Example 2.

### Comparative Example 7

Comparative Example 7 differed from Example 2 in the time of high-temperature heat treatment after the two-step surface diffusion treatment. The high-temperature heat treatment was performed for 5 h. The test results of the NIM6500C permanent magnet test system showed that the properties of the finished magnet after the diffusion were Bᵣ=12.39 KG, H_{cj}=10.20 kOe, (BH)ₘₐₓ=32.18 MGOe. The coercivity of the finished magnet was significantly lower than that of the finished magnet in Example 2.

### Example 3

An as-sintered Ce-rich MM permanent magnetic substrate magnet was prepared through induction melting, strip casting, hydrogen decrepitating, jet milling, and vacuum high-temperature sintering steps, which was represented by [(Pr_{0.2}Nd_{0.8})_{0.5}Gd_{0.1}Ce_{0.4}]₂₈Fe_{bal}Co_{0.5}Cu_{0.2}Al_{0.15}Ti_{0.25}Ga_{0.5}B_{0.96} in weight percent. The vacuum high-temperature sintering was performed at 980° C. for 10 h. (Pr₉₀La₁₀)_{0.33}H_{0.67} powder and Cu₅₀Zn₅₀ nano-powder (size of about 100 nm) with the weight ratio of 80:20 were uniformly mixed to obtain the first composite diffusion source (first diffusion source). The Pr₇₀Ho₁₀Al₁₀Ga₁₀ RE alloy powder was used as the second diffusion source. A two-step surface diffusion method was used, where the first surface diffusion treatment was performed with the first diffusion source with 2% by weight of the as-sintered Ce-rich MM permanent magnetic substrate magnet, and was performed at 920° C. for 6 h to obtain the first intermediate product; and the second surface diffusion treatment was performed with the second diffusion source with 2% by weight of the as-sintered Ce-rich MM permanent magnetic substrate magnet and performed at 890° C. for 6 h to obtain the second intermediate product. The second intermediate product was subjected to the high-temperature heat treatment at 1000° C. for 1.5 h to obtain a third intermediate product. The third intermediate product was then subjected to low-temperature heat treatment at 670° C. for 2.5 h to obtain the high-performance Ce-rich MM permanent magnetic material (finished magnet), which was tested using a NIM6500C permanent magnet test system. The test results showed that the properties of the as-sintered substrate magnet before the surface diffusion were Bᵣ=12.61 kG, H_{cj}=7.18 kOe, (BH)ₘₐₓ=32.95 MGOe; and the properties of the finished magnet after the diffusion were Bᵣ=12.93 KG, H_{cj}=14.76 kOe, and (BH)ₘₐₓ=36.40 MGOe.

### Comparative Example 8

Comparative Example 8 differed from Example 3 in composition ratio of RE hydride powder for the first surface diffusion treatment, and the RE hydride powder was (Pr₃₈La₆₂)_{0.33}H_{0.67}. The test results of the NIM6500C permanent magnet test system showed that the properties of the finished magnet after the diffusion were Bᵣ=12.68 KG, H_{cj}=9.64 kOe, (BH)ₘₐₓ=34.15 MGOe. The remanence, coercivity and maximum energy product of the finished magnet were significantly lower than that of the finished magnet in Example 3.

### Comparative Example 9

Comparative Example 9 differed from Example 3 in that after the second surface diffusion treatment, the second intermediate product was not subjected to high-temperature heat treatment, and directly subjected to low-temperature heat treatment. The test results of the NIM6500C permanent magnet test system showed that the properties of the finished magnet after the diffusion were Bᵣ=12.55 KG, H_{cj}=9.78 kOe, (BH)ₘₐₓ=32.06 MGOe. The remanence, coercivity and maximum energy product of the finished magnet were significantly lower than that of the finished magnet in Example 3.

### Comparative Example 10

Comparative Example 10 differed from Example 3 in the temperature of low-temperature heat treatment, and the low-temperature heat treatment was performed at 750° C. The test results of the NIM6500C permanent magnet test system showed that the properties of the finished magnet after the diffusion were Bᵣ=12.89 kG, H_{cj}=12.68 kOe, (BH)ₘₐₓ=35.20 MGOe. The coercivity of the finished magnet was significantly lower than that of the finished magnet in Example 3.

### Example 4

An as-sintered Ce-rich MM permanent magnetic substrate magnet was prepared through induction melting, strip casting, hydrogen decrepitating, jet milling, and vacuum high-temperature sintering steps, which was represented by [(Pr_{0.2}Nd_{0.8})_{0.48}(Ce_{0.8}MM_{0.2})_{0.5}Dy_{0.02}]_{31.5}Fe_{bal}Co_{0.5}Cu_{0.15}Al_{0.15}Nb_{0.15}Ga_{0.4}B_{0.95} in weight percent. The vacuum high-temperature sintering was performed at 1020° C. for 3 h. (Pr₉₀Dy₁₀)_{0.25}H_{0.75} powder and Cu nano-powder (size of about 100 nm) with the weight ratio of 80:20 were uniformly mixed to obtain the first composite diffusion source (first diffusion source). The Pr₅₀Tb₁₀Al₁₀Ga₁₀Cu₁₀Zn₁₀ RE alloy powder was used as the second diffusion source. A two-step surface diffusion method was used, where the first surface diffusion treatment was performed with the first diffusion source with 2.5% by weight of the as-sintered Ce-rich MM permanent magnetic substrate magnet, and was performed at 900° C. for 3 h to obtain the first intermediate product; and the second surface diffusion treatment was performed with the second diffusion source with 2% by weight of the as-sintered Ce-rich MM permanent magnetic substrate magnet and performed at 860° C. for 6 h to obtain the second intermediate product. The second intermediate product was subjected to the high-temperature heat treatment at 960° C. for 2 h to obtain a third intermediate product. The third intermediate product was then subjected to low-temperature heat treatment at 500° C. for 3 h to obtain the high-performance Ce-rich MM permanent magnetic material (finished magnet), which was tested using a NIM6500C permanent magnet test system. The test results showed that the properties of the as-sintered substrate magnet before the surface diffusion were Bᵣ=12.24 KG, H_{cj}=9.52 kOe, (BH)ₘₐₓ=34.52 MGOe; and the properties of the finished magnet after the diffusion were Bᵣ=12.71 KG, H_{cj}=18.13 kOe, and (BH)ₘₐₓ=38.67 MGOe.

### Comparative Example 11

Comparative Example 11 differed from Example 4 in selection of the first diffusion source for the first surface diffusion treatment. The first diffusion source for the first surface diffusion treatment was Cu nano-powder alone, and did not include (Pr₉₀Dy₁₀)_{0.25}H_{0.75} powder. The test results showed that the properties of the finished magnet after the diffusion were Bᵣ=12.36 KG, H_{cj}=12.78 kOe, and (BH)ₘₐₓ=35.97 MGOe. The remanence, coercivity and maximum energy product of the finished magnet were significantly lower than that of the finished magnet in Example 4.

### Comparative Example 12

Comparative Example 12 differed from Example 4 in the weight ratio of the first diffusion source. The weight ratio of (Pr₉₀Dy₁₀)_{0.25}H_{0.75} powder and Cu nano-powder was 98:2. The test results showed that the properties of the finished magnet after the diffusion were Bᵣ=12.20 kG, H_{cj}=17.60 kOe, and (BH)ₘₐₓ=37.05 MGOe. The remanence and maximum energy product of the finished magnet were significantly lower than that of the finished magnet in Example 4.

### Comparative Example 13

Comparative Example 13 differed from Example 4 in the size of the Cu powder selected for the first surface diffusion treatment. The size of Cu powder was about 20 μm. The test results showed that the properties of the finished magnet after the diffusion were Bᵣ=12.46 kG, H_{cj}=15.68 kOe, (BH)ₘₐₓ=36.85 MGOe. The remanence, coercivity and maximum energy product of the finished magnet were significantly lower than that of the finished magnet in Example 4.

### Comparative Example 14

Comparative Example 14 differed from Example 4 in composition ratio of the second diffusion source for the second 1 surface diffusion treatment. Pr₃₀Tb₁₀Al₂₀Ga₂₀Cu₁₀Zn₁₀ was used as the second diffusion source. The test results showed that the properties of the finished magnet after the diffusion were Bᵣ=12.62 KG, H_{cj}=14.25 kOe, (BH)ₘₐₓ=37.18 MGOe. The coercivity of the finished magnet was significantly lower than that of the finished magnet in Example 4.

In summary, this disclosure designs a two-step surface diffusion method for Ce-rich MM permanent magnetic material. The first surface diffusion treatment substantially increases the remanence; and the second surface diffusion treatment further increases the coercivity. Compared with the traditional grain boundary diffusion method, the high-temperature heat treatment process in the method promotes the infiltration of RE elements into the matrix phase to form a magnetically hardening shell and to improve the local magnetocrystalline anisotropy field, rather than accumulate in the intergranular phase. Moreover, the low-temperature heat treatment promotes the uniform precipitation of the continuous grain boundary phase, forming the coherent/semi-coherent interface with lower interfacial mismatch and enhancing the magnetic insulation effect. This method fully utilizes the advantages of different RE elements and alloying elements, and finally yields high-performance Ce-rich MM permanent magnetic material.

Described above are merely some embodiments of the disclosure, which are not intended to limit the disclosure. Any modifications and replacements made by those skilled in the art without departing from the spirit of the disclosure should fall within the scope of the disclosure defined by the appended claims.

What is claimed is:

1. A method of preparing a cerium (Ce)-rich misch-metal (MM) permanent magnetic material, comprising:
(1) preparing an as-sintered Ce-rich MM permanent magnetic substrate magnet;
(2) proportionally mixing a rare earth (RE) hydride powder and a nanometer metallic powder to obtain a composite diffusion source; coating the obtained composite diffusion source on upper and lower surfaces of the as-sintered Ce-rich MM permanent magnetic substrate magnet, wherein the diffusion source is less than 3% by weight of the as-sintered Ce-rich MM permanent magnetic substrate magnet; and performing a first surface diffusion treatment to obtain a first intermediate product;
(3) coating a RE alloy powder on upper and lower surfaces of the first intermediate product, wherein the RE alloy powder is less than 2% by weight of the as-sintered Ce-rich MM permanent magnetic substrate magnet; and performing a second surface diffusion treatment to obtain a second intermediate product;
(4) subjecting the second intermediate product to a first heat treatment to obtain a third intermediate product; and
(5) subjecting the third intermediate product to a second heat treatment to obtain the Ce-rich MM permanent magnetic material.

2. The method of claim 1, wherein in step (1), the as-sintered Ce-rich MM permanent magnetic substrate magnet, in weight percentage, is represented by [R_{1-a-b}(Ce₁₋ₓMMₓ)ₐR′_{b}]ₑ Fe_{bal}TₐBₑ, wherein R is selected from the group consisting of neodymium (Nd), praseodymium (Pr) and a combination thereof; R′ is selected from the group consisting of gadolinium (Gd), terbium (Tb), dysprosium (Dy), holmium (Ho), samarium (Sm), yttrium (Y) and a combination thereof; Ce represents cerium element; MM is a misch-metal comprising 50-60% by weight of Ce, 20-35% by weight of lanthanum (La), 5-10% by weight of Pr, 10-20% by weight of Nd, and 2% or less by weight of impurity elements; Fe represents iron element; T is selected from the group consisting of cobalt (Co), nickel (Ni), aluminum (Al), copper (Cu), chromium (Cr), gallium (Ga), manganese (Mn), niobium (Nb), zirconium (Zr), titanium (Ti), vanadium (V) and a combination thereof; B represents boron element; and a, x, b, c, d, and e satisfy the following conditions: 0.4≤a≤1, 0≤x≤0.8, 0≤b≤0.15, 28≤c≤35, 0.2≤d≤5, and 0.85≤e≤1.

3. The method of claim 1, wherein in step (1), the as-sintered Ce-rich MM permanent magnetic substrate magnet is prepared by sintering at 980-1080° C. and at a furnace pressure of ≤10⁻² Pa for 2-10 h.

4. The method of claim 1, wherein in step (2), the RE hydride powder, in atomic percentage, is represented by A_{1-f}H_{f}, wherein A is selected from the group consisting of Nd, Pr, La, Ce, Gd, Tb, Dy, Ho and a combination thereof, and when A is a multi-element combination, a weight percentage of Nd and Pr in A is higher than 60%; and H is hydrogen, f satisfies the following condition: 0<f≤0.75;
the nanometer metallic powder is selected from the group consisting of Cu, Ti, zinc (Zn) and a combination thereof; the nanometer metallic powder has a particle size of 5-500 nm; a weight percentage of the RE hydride powder in the composite diffusion source is equal to or higher than 50% and lower than 95%; and
the first surface diffusion treatment is performed at 800-950° C. for 2-10 h.

5. The method of claim 1, wherein in step (3), the RE alloy powder, in weight percentage, is represented by A′_{1-g}U_{g}, wherein A′ is selected from the group consisting of Nd, Pr, La, Ce, Gd, Tb, Dy, Ho and a combination thereof; U is selected from the group consisting of Al, Cu, Ga, Zn and a combination thereof, g satisfies the following condition: 0.1≤g≤0.4; and
the second surface diffusion treatment is performed at 800-920° C. for 2-10 h.

6. The method of claim 1, wherein in step (4), the first heat treatment is performed at 960-1050° C. for 0.5-2 h; and
in step (5), the second heat treatment is performed at 300-700° C. for 0.5-5 h.

7. The method of claim 1, wherein the first surface diffusion treatment, the second surface diffusion treatment, the first heat treatment, and the second heat treatment are each performed at a furnace pressure of less than 10⁻³ Pa.
